(19) United States
(12) Patent Application Publication
(10) Pub. No.: US 2022/0351493 A1
(43) Pub. Date: Nov. 3, 2022

(54) METHOD AND APPARATUS FOR DETECTING OBJECT, ELECTRONIC DEVICE AND STORAGE MEDIUM

(71) Applicant: Beijing Baidu Netcom Science Technology Co., Ltd., Beijing (CN)

(72) Inventors: Xiangbo SU, Beijing (CN); Qiman Wu, Beijing (CN); Shuai KANG, Beijing (CN); Jian WANG, Beijing (CN); Hao SUN, Beijing (CN)

(21) Appl. No.: 17/868,630

(22) Filed: Jul. 19, 2022

(30) Foreign Application Priority Data
Jul. 19, 2021 (CN) 202110814881.0

(51) Int. Cl. G06V 10/75; G06V 10/25

(52) U.S. Cl. CPC G06V 10/751; G06V 10/25; G06V 2201/07

(57) ABSTRACT

A method and apparatus for detecting an object. The method includes: inputting a to-be-detected picture into a target detection model, marking at least one region of interest in the picture using the target detection model, and determining an initial confidence that each region of interest contains a preset target object; determining concentration information of an interferent in the picture; and determining, based on the concentration information and the initial confidence corresponding to the region of interest, a target confidence that the region of interest contains the preset target object.

### CROSS-REFERENCE TO RELATED APPLICATIONS

This patent application claims the priority of Chinese Patent Application No. 202110814881.0, filed on Jul. 19, 2021, and entitled “Method and Apparatus for Detecting Object, Electronic Device and Storage Medium”, the entire content of which is herein incorporated by reference.

### TECHNICAL FIELD

The present disclosure relates to the field of artificial intelligence, in particular to computer vision and deep learning technologies, and may be applied in smart city and smart traffic scenarios.

### BACKGROUND

The existing training methods of target detection models for pictures usually use pictures with interferents and pictures without interferents together as training data to train the target detection models. Due to the low visibility of a target object in a picture with an interferent, the target object is usually blurred, which is difficult for a model to learn, which may cause a trained target detection model to have many false detections in detection results of pictures with interferents.

### SUMMARY

The present disclosure provides a method and apparatus for detecting an object, an electronic device, and a storage medium.

According to a first aspect of the present disclosure, a method for detecting an object is provided. The method includes: inputting a to-be-detected picture into a target detection model, marking at least one region of interest in the picture using the target detection model, and determining an initial confidence that each region of interest contains a preset target object; determining concentration information of an interferent in the picture; and determining, based on the concentration information and the initial confidence corresponding to the region of interest, a target confidence that the region of interest contains the preset target object.

According to a second aspect of the present disclosure, an apparatus for detecting an object is provided. The apparatus includes: an initial confidence determining module, configured to input a to-be-detected picture into a target detection model, mark at least one region of interest in the picture using the target detection model, and determine an initial confidence that each region of interest contains a preset target object; a concentration information determining module, configured to determine concentration information of an interferent in the picture; and a target confidence determining module, configured to determine, based on the concentration information and the initial confidence corresponding to the region of interest, a target confidence that the region of interest contains the preset target object.

According to a third aspect of the present disclosure, an electronic device is provided. The electronic device includes at least one processor; and a memory communicatively connected to the at least one processor. The memory stores instructions executable by the at least one processor, and the instructions, when executed by the at least one processor, cause the at least one processor to perform the method for detecting an object as described above.

According to a fourth aspect of the present disclosure, a non-transitory computer readable storage medium storing computer instructions is provided. The instructions, when executed by the at least one processor, cause the at least one processor to perform the method for detecting an object as described above.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure.

FIG. 1 shows a schematic flowchart of a method for detecting an object provided by an embodiment of the present disclosure;

FIG. 2 shows a schematic flowchart of another method for detecting an object provided by an embodiment of the present disclosure;

FIG. 3 shows a schematic flowchart of a method for determining a target confidence provided by an embodiment of the present disclosure;

FIG. 4 shows a first schematic structural diagram of an apparatus for detecting an object provided by an embodiment of the present disclosure;

FIG. 5 shows a second schematic structural diagram of the apparatus for detecting an object provided by an embodiment of the present disclosure;

FIG. 6 shows a third schematic structural diagram of the apparatus for detecting an object provided by an embodiment of the present disclosure; and

FIG. 7 shows a schematic block diagram of an example electronic device that can be used to implement the method for detecting an object provided by embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

The existing training methods of target detection models for pictures usually use pictures with interferents and pictures without interferents together as training data to train the target detection models. Due to the low visibility of a target object in a picture with an interferent, the target object is usually blurred, which is difficult for a model to learn, which may cause a trained target detection model to have many false detections in detection results of pictures with interferents.

A method and apparatus for detecting an object, an electronic device, and a storage medium provided by the embodiments of the present disclosure are intended to solve at least one of the above technical problems in the existing art.

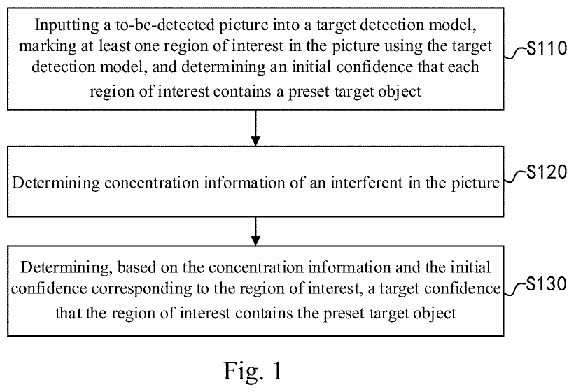

FIG. 1 shows a schematic flowchart of a method for detecting an object provided by an embodiment of the present disclosure, as shown in FIG. 1, the method may mainly include the following steps.

S110: inputting a to-be-detected picture into a target detection model, marking at least one region of interest in the picture using the target detection model, and determining an initial confidence that each region of interest contains a preset target object.

A source of the to-be-detected picture in an embodiment of the present disclosure may be determined according to an actual application scenario. Taking a monitoring scenario as an example, a video frame in a monitoring video may be used as the to-be-detected picture. A type of target detection deep learning method used by the target detection model may be determined according to actual needs. For example, direct multi-object detection method (Single Shot Multi Box Detector, SSD), refine and direct multi-object detection method (Single-Shot Refinement Neural Network for Object Detection), RefineDet, direct multi-object detection method based on efficient convolutional neural network for mobile vision applications (MobileNet based Single Shot Multi Box Detector, MobileNet-SSD), unified, real-time object detection (You Only Look Once: Unified, Real-Time Object Detection, YOLO) and so on may be used.

In an embodiment of the present disclosure, at least one preset type of target object may be defined according to a detection scenario, and a region that may contain a preset type of target object in the picture is called the region of interest, where the region of interest may be marked in the picture with a detection box in the form of a box, a circle, an ellipse, an irregular polygon, etc. The target detection model may also determine the initial confidence that each region of interest contains the preset target object, and the initial confidence represents the probability that the region of interest contains the preset target object. It may be understood that the larger the initial confidence, the higher the probability that the region of interest contains the preset target object. For example, the target detection model may be used to mark a region of interest 1 that may contain a target object of type A in the picture, and the initial confidence that the region of interest 1 contains the target object of type A is 0.65.

Alternatively, when the at least one region of interest is marked in the picture, location information of each region of interest in the at least one region of interest may be marked in the picture. The location information includes coordinate information and/or size information of the region of interest.

S120: determining concentration information of an interferent in the picture.

In an embodiment of the present disclosure, the interferent may be interfering factors that affect a detection accuracy, such as fog, haze, smoke, dust, sand, rain and snow. In this step, an algorithm for determining the concentration information of the interferent in the picture may be determined according to actual needs, for example, a dark channel estimation method may be used to determine the concentration information of the interferent in the picture.

S130: determining, based on the concentration information and the initial confidence corresponding to the region of interest, a target confidence that the region of interest contains the preset target object.

In this step, the concentration information may represent the concentration of the interferent in each region in the picture, the initial confidence corresponding to the region of interest is adjusted based on the concentration information, and the adjusted initial confidence of the region of interest is used as the target confidence that the region of interest contains the preset target object. It may be understood that the greater the concentration of the interferent in the region of interest, the higher the inaccuracy of the initial confidence, and therefore, the greater the degree of adjustment required to the initial confidence.

The method for detecting an object provided by an embodiment of the present disclosure, after determining the initial confidence that each of the region of interest in the picture contains the corresponding target object using the conventional target detection model, the initial confidence may be readjusted by using the concentration of the interferent in the picture in order to obtain the target confidence, which may improve the accuracy and reliability of the confidence, and reduce a false detection rate of detection results to a large extent.

In an embodiment of the present disclosure, before step S110, a size and/or a color parameter of the to-be-detected picture may be adjusted based on a picture specification corresponding to the target detection model.

In an embodiment of the present disclosure, after step S130, it may be determined whether the target confidence that each region of interest contains the preset target object meets a preset confidence condition; and the region of interest having the corresponding target confidence that meets the preset confidence condition is determined as the target region of interest.

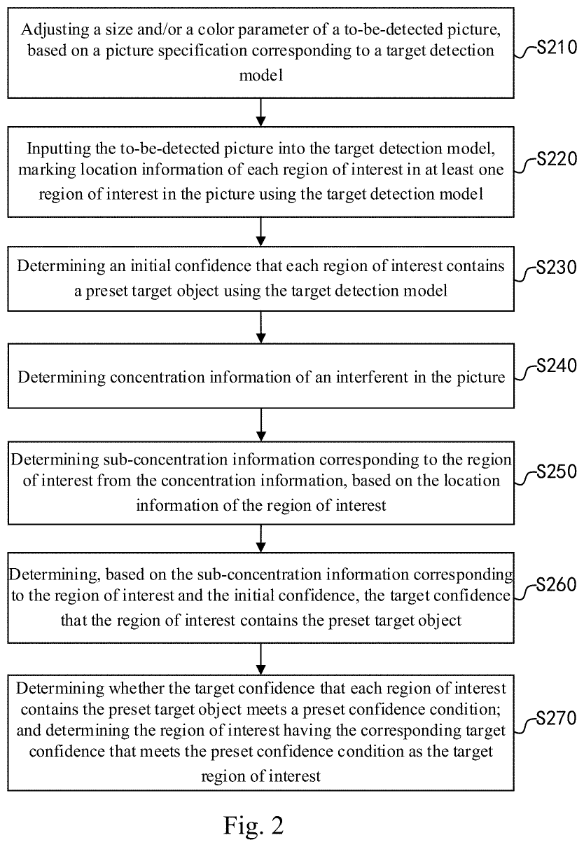

FIG. 2 shows a schematic flowchart of another method for detecting an object provided by an embodiment of the present disclosure, as shown in FIG. 2, the method may mainly include the following steps.

S210: adjusting a size and/or a color parameter of a to-be-detected picture, based on a picture specification corresponding to a target detection model.

The picture specification is determined based on sample picture parameters in a training set used in a target detection model training process. Adjusting the size and/or the color parameter of the to-be-detected picture is a preprocessing process for the picture. The purpose of the preprocessing process is to adjust a specification of the to-be-detected picture to be consistent with the specifications of sample pictures in the target detection model training process, thereby enhancing robustness of the target detection model.

Alternatively, for the preprocessing process of the to-be-detected picture, it may include scaling the picture into a fixed size (e.g., 416*416). Alternatively, the preprocessing process may further include adjusting values of three channels of each pixel in the picture, for example, subtracting corresponding preset values from the values of the three channels of each pixel in the picture. Here, the preset value corresponding to each channel may be an average value of values of the same channel in a picture set. Taking a red channel as an example, the average value of the values of the red channel of all the pictures in the picture set may be obtained, and the average value may be used as the preset value corresponding to the red channel. Assuming that the preset values corresponding to the three channels of red, green and blue of the pixel may be 104, 117 and 123 respectively, the values of the three channels of red, green and blue of each pixel in the picture may be subtracted by 104, 117 and 123 respectively, so that the value of each channel is distributed around 0.

S220: inputting the to-be-detected picture into the target detection model, marking location information of each region of interest in at least one region of interest in the picture using the target detection model.

In this embodiment of the present disclosure, an expression form of the location information may be selected according to actual needs. For example, the location information includes length and width values and at least one vertex coordinates of the region of interest, or the location information includes at least two vertex coordinates of the region of interest.

As mentioned above, the region of interest may be marked from the picture with a detection box in the form of a box, a circle, an ellipse, an irregular polygon, etc. Taking the region of interest as a box area as an example, the location information of the region of interest may be expressed in the form of length and width values and one vertex coordinate, and the location information of the region of interest may be described as (x, y, w, h), where x and y are the coordinates of one vertex of the region of interest, w is the width of the region of interest, and his the length of the region of interest.

In an embodiment of the present disclosure, for other description in step S220, reference may be made to the description in step S110, and repeated description thereof will be omitted.

S230: determining an initial confidence that each region of interest contains a preset target object using the target detection model.

The location information of the region of interest may be described as (x, y, w, h), the location information of the region of interest and the initial confidence may be described together as (x, y, w, h, conf), and conf is the initial confidence that the region of interest contains the preset target object. In an embodiment of the present disclosure, other description in step S230 may refer to the description in step S110, and repeated description thereof will be omitted.

S240: determining concentration information of an interferent in the picture.

In an embodiment of the present disclosure, the interferent may be interfering factors that affect a detection accuracy, such as fog, haze, smoke, dust, sand, rain and snow. In this step, an algorithm for determining the concentration information of the interferent in the picture may be determined according to actual needs, for example, a dark channel estimation method may be used to determine the concentration information of the interferent in the picture.

S250: determining sub-concentration information corresponding to the region of interest from the concentration information, based on the location information of the region of interest.

In this step, the concentration information may represent the concentration of the interferent in each region in the picture. It may be understood that, therefore, the sub-concentration information corresponding to each of the region of interest may be determined from the concentration information, based on the location information of the region of interest.

S260: determining, based on the sub-concentration information corresponding to the region of interest and the initial confidence, the target confidence that the region of interest contains the preset target object.

The sub-concentration information corresponding to each region of interest may represent the concentration of the interferent in the region of interest, the initial confidence of the region of interest is adjusted based on the corresponding sub-concentration information, and the adjusted initial confidence of the region of interest is used as the target confidence that the region of interest contains the preset target object. It may be understood that the greater the concentration of the interferent in the region of interest, the higher the inaccuracy of the initial confidence, and therefore, the greater the degree of adjustment required to the initial confidence. In the embodiments of the present disclosure, a process of determining the target confidence will be described in detail in the subsequent content, and detailed description thereof will be omitted.

S270: determining whether the target confidence that each region of interest contains the preset target object meets a preset confidence condition; and determining the region of interest having the corresponding target confidence that meets the preset confidence condition as the target region of interest.

In an embodiment of the present disclosure, the preset confidence condition may be determined according to actual design requirements. For example, a confidence threshold may be set. When the target confidence corresponding to a certain region of interest is greater than the confidence threshold, it may be determined that the target confidence corresponding to the region of interest meets the preset confidence condition, and the region of interest is determined as the target region of interest.

In an embodiment of the present disclosure, after the target region of interest is determined, a detection frame corresponding to the target region of interest may be kept, and a detection frame corresponding to a non-target region of interest may be deleted.

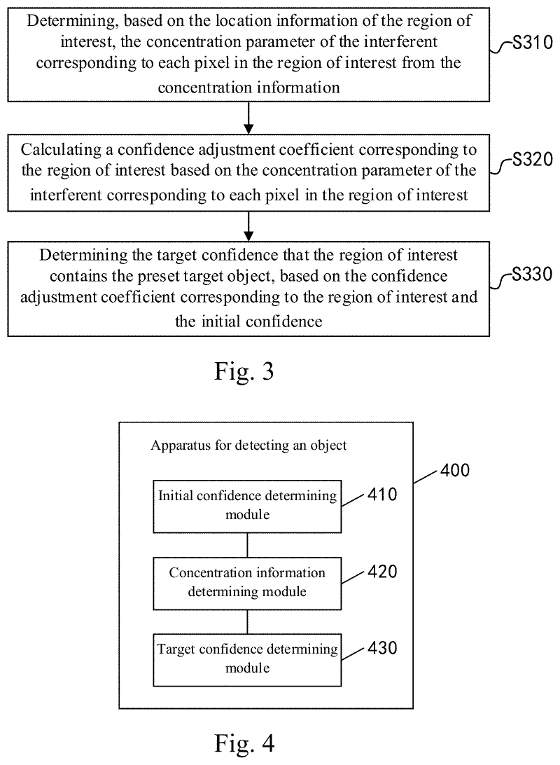

FIG. 3 shows a schematic flowchart of a method for determining a target confidence provided by an embodiment of the present disclosure, as shown in FIG. 3, the method may mainly include the following steps.

S310: determining, based on the location information of the region of interest, the concentration parameter of the interferent corresponding to each pixel in the region of interest from the concentration information.

In an embodiment of the present disclosure, the concentration information includes the concentration parameter of the interferent corresponding to each pixel in the picture, the larger the concentration parameter, the greater the concentration of the interferent corresponding to the pixel. By determining the concentration of the interferent at the pixel level, the concentration of the interferent in the region of interest may be represented in a more refined approach. Alternatively, a parameter range may be preset, and the concentration parameter of the interferent corresponding to each pixel is a value within the parameter range. For example, a value range of the concentration parameter may be set to between 0 and 1, that is, the concentration parameter of the interferent corresponding to each pixel is a value between 0 and 1.

S320: calculating a confidence adjustment coefficient corresponding to the region of interest based on the concentration parameter of the interferent corresponding to each pixel in the region of interest.

As mentioned above, the greater the concentration of the interferent in the region of interest, the higher the inaccuracy of the initial confidence, so that the initial confidence may be appropriately adjusted to be lower to make the probability of the region of interest determined as the target region of interest reduce, so as to avoid false detections to a large extent.

In an embodiment of the present disclosure, the larger the concentration parameter of the interferent corresponding to each pixel in the region of interest, the greater the concentration of the interferent in the region of interest, in this regard, the confidence adjustment coefficient corresponding to the region of interest should be smaller, so that a small target confidence can be calculated based on the confidence adjustment coefficient corresponding to the region of interest and the initial confidence, thereby avoiding false detections to a large extent. That is, the confidence adjustment coefficient corresponding to the region of interest should be negatively correlated as a whole with the concentration parameter of the interferent corresponding to each pixel in the region of interest.

Alternatively, the value range of the concentration parameter is between 0 and 1. In an embodiment of the present disclosure, an average concentration parameter corresponding to the region of interest may be calculated based on the concentration parameter of the interferent corresponding to each pixel in the region of interest; and a difference between 1 and the average concentration parameter may be used as the confidence adjustment coefficient corresponding to the region of interest.

Specifically, the concentration parameters of the interferent corresponding to all the pixels in the region of interest may be added up to obtain a sum of the concentration parameters, and the average concentration parameter corresponding to the region of interest may be obtained by dividing the sum of the concentration parameters by the number of pixels in the region of interest. It may be understood that since the value range of the concentration parameter is between 0 and 1, a range of the average concentration parameter corresponding to the region of interest is also between 0 and 1. If the average concentration parameter is denoted as p_avg, then the confidence adjustment coefficient corresponding to the region of interest is (1−p_avg). It may be understood that the larger the average concentration parameter corresponding to the region of interest, the smaller the confidence adjustment coefficient corresponding to the region of interest, that is, the confidence adjustment coefficient corresponding to the region of interest is negatively correlated as a whole with the concentration parameter of the interferent corresponding to each pixel in the region of interest.

S330: determining the target confidence that the region of interest contains the preset target object, based on the confidence adjustment coefficient corresponding to the region of interest and the initial confidence.

In an embodiment of the present disclosure, a product of the confidence adjustment coefficient corresponding to the region of interest and the initial confidence may be calculated, and the product may be determined as the target confidence that the region of interest contains the preset target object. For example, the initial confidence that the region of interest contains the preset target object is denoted as conf, and the confidence adjustment coefficient corresponding to the region of interest is (1−p_avg), then the target confidence that the region of interest contains the preset target object is conf (1−p_avg).

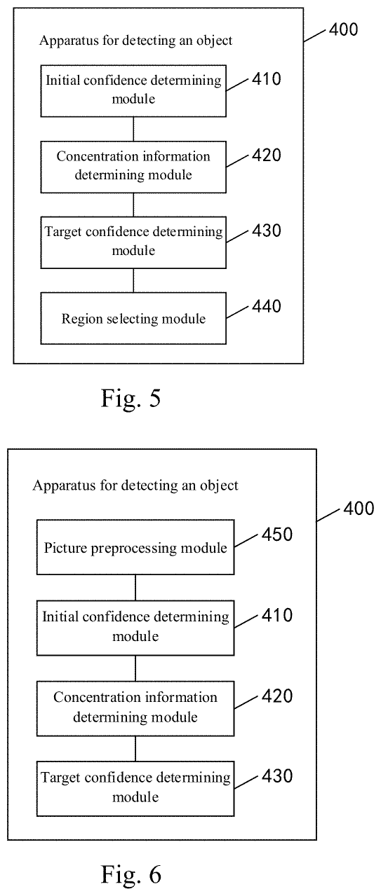

Based on the same principles as the above method for detecting an object, FIG. 4 shows a first schematic structural diagram of an apparatus for detecting an object provided by an embodiment of the present disclosure, FIG. 5 shows a second schematic structural diagram of the apparatus for detecting an object provided by an embodiment of the present disclosure, and FIG. 6 shows a third schematic structural diagram of the apparatus for detecting an object provided by an embodiment of the present disclosure. As shown in FIG. 4, an apparatus 400 for detecting an object includes an initial confidence determining module 410, a concentration information determining module 420 and a target confidence determining module 430.

The initial confidence determining module 410 is configured to input a to-be-detected picture into a target detection model, mark at least one region of interest in the picture using the target detection model, and determine an initial confidence that each region of interest contains a preset target object.

The concentration information determining module 420 is configured to determine concentration information of an interferent in the picture.

The target confidence determining module 430 is configured to determine, based on the concentration information and the initial confidence corresponding to the region of interest, a target confidence that the region of interest contains the preset target object.

The apparatus for detecting an object provided by an embodiment of the present disclosure, after determining the initial confidence that each region of interest in the picture contains the corresponding target object using the conventional target detection model, the initial confidence may be readjusted by using the concentration of the interferent in the picture in order to obtain the target confidence, which may improve the accuracy and reliability of the confidence, and reduce a false detection rate of detection results to a large extent.

In an embodiment of the present disclosure, the initial confidence determining module 410 configured to mark at least one region of interest in the picture, is specifically configured to: mark location information of each region of interest in the at least one region of interest in the picture; where the location information includes coordinate information and/or size information of the region of interest.

In an embodiment of the present disclosure, the target confidence determining module 430 configured to determine, based on the concentration information and the initial confidence corresponding to the region of interest, the target confidence that the region of interest contains the preset target object, is specifically configured to: determine sub-concentration information corresponding to the region of interest from the concentration information, based on the location information of the region of interest; and determine, based on the sub-concentration information corresponding to the region of interest and the initial confidence, the target confidence that the region of interest contains the preset target object.

In an embodiment of the present disclosure, the concentration information includes a concentration parameter of the interferent corresponding to each pixel in the picture. The target confidence determining module 430 configured to determine sub-concentration information corresponding to the region of interest from the concentration information, based on the location information of the region of interest, is specifically configured to: determine, based on the location information of the region of interest, the concentration parameter of the interferent corresponding to each pixel in the region of interest from the concentration information.

In an embodiment of the present disclosure, the target confidence determining module 430 configured to determine, based on the sub-concentration information corresponding to the region of interest and the initial confidence, the target confidence that the region of interest contains the preset target object, is specifically configured to: calculate a confidence adjustment coefficient corresponding to the region of interest based on the concentration parameter of the interferent corresponding to each pixel in the region of interest; and determine the target confidence that the region of interest contains the preset target object, based on the confidence adjustment coefficient corresponding to the region of interest and the initial confidence.

In an embodiment of the present disclosure, a value range of the concentration parameter is between 0 and 1. The target confidence determining module 430 configured to calculate the confidence adjustment coefficient corresponding to the region of interest based on the concentration parameter of the interferent corresponding to each pixel in the region of interest, is specifically configured to: calculate an average concentration parameter corresponding to the region of interest based on the concentration parameter of the interferent corresponding to each pixel in the region of interest; and use a difference between 1 and the average concentration parameter as the confidence adjustment coefficient corresponding to the region of interest.

In an embodiment of the present disclosure, the target confidence determining module 430 configured to determine the target confidence that the region of interest contains the preset target object, based on the confidence adjustment coefficient corresponding to the region of interest and the initial confidence, is specifically configured to: calculate a product of the confidence adjustment coefficient corresponding to the region of interest and the initial confidence; and determine the product as the target confidence that the region of interest contains the preset target object.

In an embodiment of the present disclosure, as shown in FIG. 5, the apparatus 400 for detecting an object further includes a region selecting module 440, and the region selecting module 440 is configured to: determine whether the target confidence that each region of interest contains the preset target object meets a preset confidence condition; and determine the region of interest having the corresponding target confidence that meets the preset confidence condition as the target region of interest.

In an embodiment of the present disclosure, as shown in FIG. 6, the apparatus 400 for detecting an object further includes a picture preprocessing module 450, and the picture preprocessing module 450 is configured to: adjust a size and/or a color parameter of the to-be-detected picture, based on a picture specification corresponding to the target detection model.

It may be understood that the above modules of the apparatus for detecting an object in an embodiment of the present disclosure have the function of implementing the corresponding steps of the above method for detecting an object. The function may be implemented by hardware or by executing corresponding software by hardware. The hardware or software includes one or more modules corresponding to the above function. The module may be software and/or hardware, and the above modules may be implemented independently, or a plurality of modules may be integrated and implemented. For a functional description of each module of the above apparatus for detecting an object, reference may be made to the corresponding description of the above method for detecting an object, and detailed description thereof will be omitted.

In the technical solution of the present disclosure, the acquisition, storage, and application of involved user personal information are in conformity with relevant laws and regulations, and do not violate public order and good customs.

According to an embodiment of the present disclosure, the present disclosure further provides an electronic device, a readable storage medium, and a computer program product.

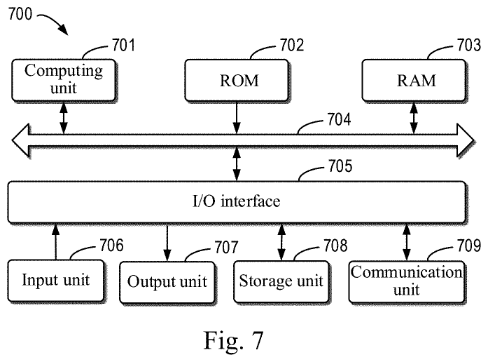

FIG. 7 shows a schematic block diagram of an example electronic device that can be used to implement the method for detecting an object provided by embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 7, the electronic device 700 includes a computing unit 701, which may perform various appropriate actions and processing, based on a computer program stored in a read-only memory (ROM) 702 or a computer program loaded from a storage unit 708 into a random access memory (RAM) 703. In the RAM 703, various programs and data required for the operation of the electronic device 700 may also be stored. The computing unit 701, the ROM 702, and the RAM 703 are connected to each other through a bus 704. An input/output (I/O) interface 705 is also connected to the bus 704.

A plurality of components in the electronic device 700 are connected to the I/O interface 705, including: an input unit 706, for example, a keyboard and a mouse; an output unit 707, for example, various types of displays and speakers; the storage unit 708, for example, a disk and an optical disk; and a communication unit 709, for example, a network card, a modem, or a wireless communication transceiver. The communication unit 709 allows the electronic device 700 to exchange information/data with other devices over a computer network such as the Internet and/or various telecommunication networks.

The computing unit 701 may be various general-purpose and/or dedicated processing components having processing and computing capabilities. Some examples of the computing unit 701 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 701 performs the various methods and processes described above, such as the method for detecting an object. For example, in some embodiments, the method for detecting an object may be implemented as a computer software program, which is tangibly included in a machine readable medium, such as the storage unit 708. In some embodiments, part or all of the computer program may be loaded and/or installed on the electronic device 700 via the ROM 702 and/or the communication unit 709. When the computer program is loaded into the RAM 703 and executed by the computing unit 701, one or more steps of the method for detecting an object described above may be performed. Alternatively, in other embodiments, the computing unit 701 may be configured to perform the method for detecting an object by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for detecting an object, the method comprising:
inputting a to-be-detected picture into a target detection model, marking at least one region of interest in the picture using the target detection model, and determining an initial confidence that each region of interest contains a preset target object;
determining concentration information of an interferent in the picture; and
determining, based on the concentration information and the initial confidence corresponding to the region of interest, a target confidence that the region of interest contains the preset target object.

2. The method according to claim 1, wherein marking at least one region of interest in the picture comprises:
marking location information of each region of interest in the at least one region of interest in the picture;
wherein, the location information comprises coordinate information and/or size information of the region of interest.

3. The method according to claim 2, wherein determining, based on the concentration information and the initial confidence corresponding to the region of interest, the target confidence that the region of interest contains the preset target object, comprises:
determining sub-concentration information corresponding to the region of interest from the concentration information, based on the location information of the region of interest; and
determining, based on the sub-concentration information corresponding to the region of interest and the initial confidence, the target confidence that the region of interest contains the preset target object.

4. The method according to claim 3, wherein the concentration information comprises a concentration parameter of the interferent corresponding to each pixel in the picture; and
determining sub-concentration information corresponding to the region of interest from the concentration information, based on the location information of the region of interest, comprises:
determining, based on the location information of the region of interest, the concentration parameter of the interferent corresponding to each pixel in the region of interest from the concentration information.

5. The method according to claim 4, wherein determining, based on the sub-concentration information corresponding to the region of interest and the initial confidence, the target confidence that the region of interest contains the preset target object, comprises:
calculating a confidence adjustment coefficient corresponding to the region of interest based on the concentration parameter of the interferent corresponding to each pixel in the region of interest; and
determining the target confidence that the region of interest contains the preset target object, based on the confidence adjustment coefficient corresponding to the region of interest and the initial confidence.

6. The method according to claim 5, wherein a value range of the concentration parameter is between 0 and 1; and
calculating the confidence adjustment coefficient corresponding to the region of interest based on the concentration parameter of the interferent corresponding to each pixel in the region of interest, comprises:
calculating an average concentration parameter corresponding to the region of interest based on the concentration parameter of the interferent corresponding to each pixel in the region of interest; and
using a difference between 1 and the average concentration parameter as the confidence adjustment coefficient corresponding to the region of interest.

7. The method according to claim 5, wherein determining the target confidence that the region of interest contains the preset target object, based on the confidence adjustment coefficient corresponding to the region of interest and the initial confidence, comprises:
calculating a product of the confidence adjustment coefficient corresponding to the region of interest and the initial confidence; and
determining the product as the target confidence that the region of interest contains the preset target object.

8. The method according to claim 1, wherein after determining the target confidence that the region of interest contains the preset target object, the method further comprises:
determining whether the target confidence that each region of interest contains the preset target object meets a preset confidence condition; and
determining the region of interest having the corresponding target confidence that meets the preset confidence condition as the target region of interest.

9. The method according to claim 1, wherein before inputting the to-be-detected picture into the target detection model, the method further comprises:
adjusting a size and/or a color parameter of the to-be-detected picture, based on a picture specification corresponding to the target detection model.

10. An electronic device, comprising:
at least one processor; and
a memory communicatively connected to the at least one processor;
wherein the memory stores one or more instructions executable by the at least one processor, and the one or more instructions, when executed by the at least one processor, cause the at least one processor to perform operations, the operations comprising:
inputting a to-be-detected picture into a target detection model, marking at least one region of interest in the picture using the target detection model, and determining an initial confidence that each region of interest contains a preset target object;
determining concentration information of an interferent in the picture; and
determining, based on the concentration information and the initial confidence corresponding to the region of interest, a target confidence that the region of interest contains the preset target object.

11. The electronic device according to claim 10, wherein marking at least one region of interest in the picture, comprises:
marking location information of each region of interest in the at least one region of interest in the picture;
wherein, the location information comprises coordinate information and/or size information of the region of interest.

12. The electronic device according to claim 11, wherein determining, based on the concentration information and the initial confidence corresponding to the region of interest, the target confidence that the region of interest contains the preset target object, comprises:
determining sub-concentration information corresponding to the region of interest from the concentration information, based on the location information of the region of interest; and
determining, based on the sub-concentration information corresponding to the region of interest and the initial confidence, the target confidence that the region of interest contains the preset target object.

13. The electronic device according to claim 12, wherein the concentration information comprises a concentration parameter of the interferent corresponding to each pixel in the picture; and
determining sub-concentration information corresponding to the region of interest from the concentration information, based on the location information of the region of interest, comprises:
determining, based on the location information of the region of interest, the concentration parameter of the interferent corresponding to each pixel in the region of interest from the concentration information.

14. The electronic device according to claim 13, wherein determining, based on the sub-concentration information corresponding to the region of interest and the initial confidence, the target confidence that the region of interest contains the preset target object, comprises:
calculating a confidence adjustment coefficient corresponding to the region of interest based on the concentration parameter of the interferent corresponding to each pixel in the region of interest; and
determining the target confidence that the region of interest contains the preset target object, based on the confidence adjustment coefficient corresponding to the region of interest and the initial confidence.

15. The electronic device according to claim 14, wherein a value range of the concentration parameter is between 0 and 1; and
calculating the confidence adjustment coefficient corresponding to the region of interest based on the concentration parameter of the interferent corresponding to each pixel in the region of interest, comprises:
calculating an average concentration parameter corresponding to the region of interest based on the concentration parameter of the interferent corresponding to each pixel in the region of interest; and
using a difference between 1 and the average concentration parameter as the confidence adjustment coefficient corresponding to the region of interest.

16. The electronic device according to claim 14, wherein determining the target confidence that the region of interest contains the preset target object, based on the confidence adjustment coefficient corresponding to the region of interest and the initial confidence, comprises:
calculating a product of the confidence adjustment coefficient corresponding to the region of interest and the initial confidence; and
determining the product as the target confidence that the region of interest contains the preset target object.

17. The electronic device according to claim 10, wherein after determining the target confidence that the region of interest contains the preset target object, the operations further comprise:
determining whether the target confidence that each region of interest contains the preset target object meets a preset confidence condition; and
determining the region of interest having the corresponding target confidence that meets the preset confidence condition as the target region of interest.

18. The electronic device according to claim 10, wherein before inputting the to-be-detected picture into the target detection model, the operations further comprise:
adjusting a size and/or a color parameter of the to-be-detected picture, based on a picture specification corresponding to the target detection model.

19. A non-transitory computer readable storage medium storing computer instructions, wherein, the computer instructions, when executed by a processor, cause the processor to perform operations, the operations comprising:
inputting a to-be-detected picture into a target detection model, marking at least one region of interest in the picture using the target detection model, and determining an initial confidence that each region of interest contains a preset target object;
determining concentration information of an interferent in the picture; and
determining, based on the concentration information and the initial confidence corresponding to the region of interest, a target confidence that the region of interest contains the preset target object.
